(19) United States
(12) Patent Application Publication
(10) Pub. No.: US 2005/0279013 A1
(43) Pub. Date: Dec. 22, 2005

(54) Spear fishing floatable fish box

(76) Inventor: John E. Iwaniec, Waimanalo, HI (US)

Correspondence Address: Donald W. Meeker, 924 East Ocean Front #E, Newport Beach, CA, 92661, US

(21) Appl. No.: 10/872,085

(22) Filed: Jun. 17, 2004

(51) Int. Cl. A01K 97/20; A01K 97/06

(52) U.S. Cl. 43/55; 43/54.1

(57) ABSTRACT

A floatable fish box for spear fishing that has a hollow interior holding area, an elevated hatch with spear fishing flag stickers thereon, a sealed latched lid, a spool for either anchor line or spear line, holders for spear guns, handles, and wheels for ease of moving on dry ground.

### BACKGROUND OF THE INVENTION

1. Field of the Invention

The present invention relates to the sport of spear fishing and particularly to a floatable device with a hollow interior holding area, an elevated hatch with spear fishing flag stickers thereon, a sealed latched lid, a spool for either anchor line or spear line, holders for spear guns, handles, and wheels for ease of moving on dry ground.

2. Description of the Prior Art

Floats for use in skin diving and spear fishing are well known. However, such floats have been found to possess one or more deficiencies. For example, inflatable floats may be punctured by a knife or spear gun, thereby causing the float to sink. If the inflatable float has a receptacle for holding fish or valuables, those items will be lost as well.

Prior art U.S. Pat. No. 3,182,340, issued May 11, 1965 to Gentile, claims a float for use in skin diving, lifesaving and the like. The float comprises an annular ring-type frame or body, said frame having a recessed groove in the top surface thereof, and a plurality of fasteners spaced around the groove. The center opening of the ring-type frame is equipped with a basket for holding articles or objects, which is held in place by the fasteners. The fasteners may also hold items such as spear guns used by skin divers. The float may also be equipped with a “diver down” warning flag.

Prior art U.S. Pat. No. 5,551,186, issued Sep. 3, 1996 to Harada, provides a fish catch chest that comprises a boat-shaped hull capable of floatable upon a top surface of a body of water. A receptacle is provided that has an open top with a compartment therein and is an integral part of the boat-shaped hull. The compartment will hold fish caught by a skin diver in the body of water. A lid is for closing the open top of the receptacle and sealing the compartment.

Prior art U.S. Pat. No. 6,273,773, issued Aug. 14, 2001 to Bourke, discloses a scuba diver's marker buoy and dry box. The dive buoy/dry box assembly comprises a hollow canister-like main float assembly having a hinged latchable air-tight sealing lid, a collapsible marker flat and mast removably attached to the lid, a collapsible staff and ballast weight removably attached to the bottom of the float assembly and a buoy line storage reel detachably mounted surrounding the float assembly in a horizontal plane. The marker flat, mast ballast weight and staff are all storable in said float assembly when collapsed.

Prior art U.S. Pat. No. 4,871,079, issued Oct. 3, 1989 to Doucette, provides an integral floating cooler structure, which includes a barge member having a barge bottom and barge sides with a storage chest having a chest bottom formed in common with the barge bottom, and chest sides of less thickness that the barge sides and having lower portions formed in common with the barge sides. The chest bottom and said chest sides are of thickness sufficient to provide thermal insulation. The barge bottom and the barge sides are displacement volume sufficient to provide buoyancy for the cooler structure. The exterior surfaces of the chest sides, barge sides and the barge bottom form a common exterior surface for the cooler structure. The interior surface of the chest bottom and the chest sides forms a common interior surface for the cooler structure. Color pigment may be included in the material forming the skin of the cooler structure for an attractive appearance and also to give greater visibility to the apparatus as given to marker buoys, life preservers, and the like.

Prior art U.S. Pat. No. 4,905,404, issued Mar. 6, 1990 to Pasion, shows a floating fish basket for use by divers and spear fishermen, which has a frame removably secured to a flotation ring. A coaxial wire mesh bag is suspended from the frame within the flotation ring for containing fish and other sea animals. The frame and mesh bag have aligned openings which may be selectively closed by a pivotal door mounted by a hinge on the frame. A chain extends between the bottom of the bag and the door and is operative upon opening the door to partially axially collapse the mesh bag to enable an individual to have access to bottom portions of the bag. The chain may be adjusted in length to shorten the axial extent of the bag for use in shallow water. A socket on the frame is provided for mounting a staff of a diving flag. The flotation ring may be captured between upper and lower frame members secured by threaded fasteners or alternatively secured by frictional engagement within a frame recess or held in place by VELCRO™ fastening straps.

Prior art U.S. Pat. No. 6,652,339, issued Nov. 25, 2003 to Carmichael, claims an inflatable diver marker and collection bag, which can be utilized by a diver for collecting lobster, conch, etc., as well as providing for a diver location marker to boats and other water vehicles traveling in the vicinity of the diver. The dive marker/collection bag also provides for an individual ascent line for the diver. The inflatable dive marker/collection bag allows the diver to send the collected items to the surface without the diver having to surface. In one embodiment, the shape of at least the bottom half of the collection bag is “bell” shaped to help prevent the collected items from escaping when additional items to the collection bag.

Prior art U.S. Pat. No. 6,200,026, issued Mar. 13, 2001 to Carmichael, describes an inflatable diver marker and collection bag, which can be utilized by a diver for collecting lobster, conch, etc., as well as providing for a diver location marker to boats and other water vehicles traveling in the vicinity of the diver. The dive marker/collection bag also provides for an individual ascent line for the diver. The inflatable dive marker/collection bag allows the diver to send the collected items to the surface without the diver having to surface. In one embodiment, the shape of at least the bottom half of the collection bag is “bell” shaped to help prevent the collected items from escaping when additional items to the collection bag.

Prior art U.S. Pat. No. 5,163,694, issued Nov. 17, 1992 to Reichek, shows a buoyant support for outdoor gear such as fishing, hunting, or archery equipment. The support in one aspect has a body member with one or more compartments for receiving and holding equipment and with one or more pairs of wheels attached to the body member to facilitate transportability; and sized, in one aspect to be suitable as a personal floatation device. In another aspect the support includes a box removably mounted on or in the body member, the box with or without a lid suitable for holding outdoor gear.

Prior art U.S. Pat. No. 5,299,962, issued Apr. 5, 1994 to Saulnier, concerns a buoy for storing a line connected to an underwater object, having a hollow casing formed of resilient plastics material and having two side portions each with bearings. A reel for carrying the line has shaft portions rotatable in the bearings. The reel is a buoyant hollow body also formed of flexible plastics material and is provided with a fluid inlet for inflation from an axially collapsed state, in which the reel and its shaft portions can be fitted between the side portions, to an inflated state wherein the shaft portions are rotatably held in the bearings. A staff or mast device may be added, which includes an adapter part which can be snapped into the upper end of the buoy and which holds an elongated mast projecting upwardly from the upper end of the buoy. This mast can hold a flag, for example when being used to mark the position of a diver.

Prior art U.S. Pat. No. 5,865,656, issued Feb. 2, 1999 to Sims, indicates a marker buoy with self-deploying anchor. The small, lightweight, reusable marker buoy is provided for marking a selected location on a body of water. The marker buoy has a buoyant float formed with an upwardly open well within which is mounted a rotatable anchor line spool. A conduit directs anchor line from the spool, through the float body, and out the bottom of the float where it is attached to a weighted anchor. A spring biased friction plate within the well provides resistance to rotation of the spool and a nut that secures the spool on an upwardly projecting spindle can be tightened to press the spool against the friction plate with a predetermined force to provide a pre-selected resistance to rotation of the spool and thus a pre-selected tension on the anchor line. In use, the resistance is set to allow the weighted anchor to draw anchor line from the spool as the anchor sinks but to resist further, deployment of anchor line from the spool due to wave and wind action after the anchor has fully deployed. A fin and current direction indicator line is provided to indicate visually the direction of current in a region where the buoy is deployed. A diver's flag, light stick or other indicator can be inserted into the top of the buoy or mounted on the upper tip of the spindle if desired as further indicia of the location and nature of the buoy.

Prior art U.S. Pat. No. 4,927,395, issued May 22, 1990 to Saulnier, puts forth a combined buoy and anchor device for fishermen that comprises a buoy body with a hollow interior and having its upper and closeable by a lid, a reel rotatably mounted in the buoy body and to which is secured the inner end of a cable, and an anchor connected to an outer end of the cable. The anchor includes a shank and a plate detachable from the shank, the plate and the lid having inter-engaging formations so that the plate can be retained in place on the lid. The buoy preferably includes a generally cylindrical upper portion surrounding the hollow interior, and a reel-containing lower portion separated from the upper portion by a wall. The hollow interior of the buoy can be used for holding bait or tackle.

Prior art U.S. Pat. No. 4,238,864, issued Dec. 16, 1980 to Kealoha, illustrates a diver's floater that has a spherical float body with a circumferential groove there about in which a line may be stored, which line connects the float body to the diver. A clip, attached to the float body, under which pre-selected turns of the line may be secured, serves the dual purpose of preventing excessive line from unwrapping and providing distance indications to the diver. In one embodiment of the invention, wherein the float body is hollow, access to the float body interior is provided so that equipment may be stored therein. A support is also provided for storing equipment and the like external to the float body.

What is needed is a floatable fish box with a sealed compartment to store fish when spear fishing primarily to avoid attracting sharks to the bleeding fish.

### SUMMARY OF THE INVENTION

An object of the present invention is to provide a floatable fish box with a sealed compartment to store fish when spear fishing primarily to avoid attracting sharks to the bleeding fish.

An added object of the present invention is to provide an internal compartment, which may contain ice and/or water to keep the fish fresh and also to carry food and beverages.

Another object of the present invention is to provide a floatable fish box with racks to hold the spear guns and a spool to hold the spear lines or an anchor for reef fishing.

One more object of the present invention is to provide a floatable fish box with an attachable line, which can be towed behind a boat.

An additional object of the present invention is to provide a floatable fish box with handles on all sides for hanging on while loading the fish.

A further object of the present invention is to provide a front handle and rear wheels for ease of handling of the floatable fish box on land.

A contributory object of the present invention is to provide a large enough compartment to store equipment, such as fins and wetsuit, for ease of transporting everything together on land.

An ensuing object of the present invention is to provide a floatable fish box with a large visible area on at least two sides for displaying dive flags for the safety of the spear fisherman from passing boats.

In brief, a floatable craft with a hollow interior similar to a small kayak is provided with a rubber sealed cover to maintain the fish holding compartment tightly sealed to avoid attracting sharks and prevent the fish from falling out and losing the fish if the craft tips over. The interior compartment can hold ice and/or water for preserving the speared fish and also for storing food and beverages.

The central hatch is elevated with the sealed cover on top for further protection against a spill. The sides of the hatch also provide a large area to display diving flags for the safety of the spear fisherman from passing boats and also in compliance with the law.

Racks provided on the sides can hold the spear guns and a recessed spool on the front of the craft can hold line for spear fishing, anchor line, or towing line. Handles on all sides enable the spear fisherman to grab on while loading in the speared fish. A front handle and rear wheels enable easy of handling on shore and also for launching and beaching the craft. Sufficient storage room is provided for all the equipment, such as fins and wetsuit for ease of transporting them on land.

An advantage of the present invention is that it has a large holding area.

An additional advantage of the present invention is that the holding area is sealed tightly.

Another advantage of the present invention is that it moves easily on land.

One more advantage of the present invention is that it has spear gun racks.

Yet another advantage of the present invention is that it alerts boat operators to divers in the area.

Still another advantage of the present invention is that it is sturdily constructed.

Another advantage of the present invention is that the recessed spool keeps lines from tangling.

A further advantage of the present invention is that it cannot be punctured.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a side elevational view of the floatable fish box of the present invention with the recessed line spool in partial section;

FIG. 2 is a top plan view of the floatable fish box of FIG. 1;

FIG. 3 is a front elevational view of the floatable fish box of FIG. 1;

FIG. 4 is a rear elevational view of the floatable fish box of FIG. 1.

### BEST MODE FOR CARRYING OUT THE INVENTION

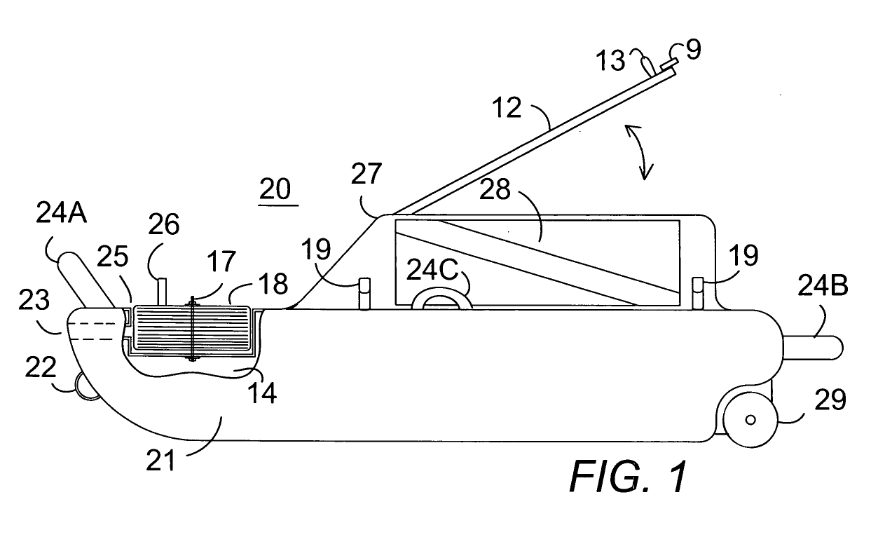

In FIGS. 1-4, a floatable fish box 20 for spear fishing comprises a floatable craft having an external shell 21 with a hollow interior 14 adapted for floating and storing speared fish. The external shell 21 is sufficiently insulated so that the hollow interior 14 is adapted to hold ice and water for preserving any speared fish and food and beverages stored therein. The hollow interior 14 is sufficiently large to store spear fishing equipment in addition to any speared fish. The external shell 21 is preferably formed of blow molded plastic.

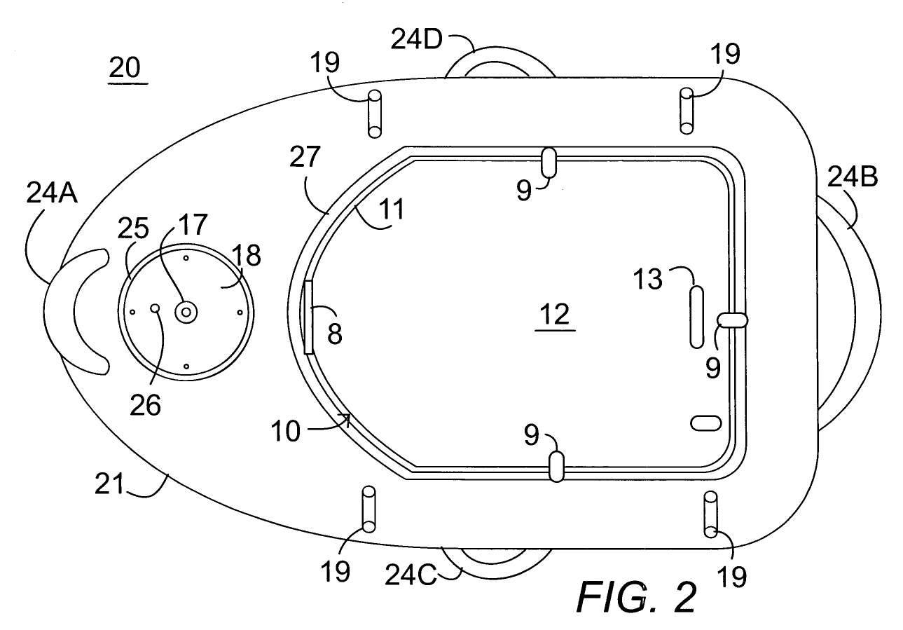

In FIGS. 1 and 2, the floatable fish box 20 also comprises an elevated hatchway 27 with a top opening 10, a removable cover 12 over the opening, a seal 11 between the cover 12 and the opening 10 and a secure latch 9 to maintain the cover 12 in place over the hatch opening 10 to prevent losing any speared fish and avoid attracting sharks and a handle 13 for pivoting the cover open on a hinge 8 preferably at the front of the cover. The elevated hatch 27 has an external display area on two or more sides for displaying a dive flag 28, as seen in FIGS. 1 and 4.

The floatable fish box 20 further comprises a means for storing one or more spear guns comprising paired U-shaped racks 19 attached to the exterior of the shell 21. The device 20 also has a recessed spool 18, rotatable with a handle 26 around a central axle 17, within a recess 25 in the external shell 21 at a front end of the floatable fish box 20, as shown in FIGS. 1 and 2. The recessed spool 18 is adapted for holding line for multiple uses including a spear line, an anchor line, and a towline. The floatable fish box 20 also comprises a handle 24A, 24B, 24C, and 24D on each side of the floatable fish box 20, for grasping while loading in speared fish into the top opening 10 in the hatchway 27. The line may extend out a front opening 23 in the shell 21 communicating with the spool 18.

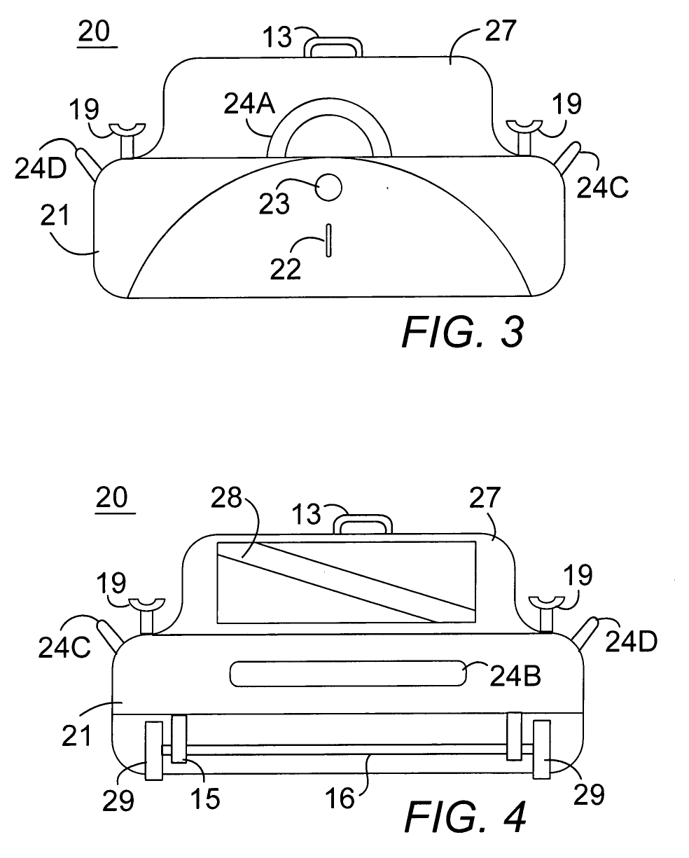

The floatable fish box 20 has a front handle 24A and a pair of rear wheels 29, attached to the rear of the floatable fish box 20 by an axle 16 and brackets 15 as shown in FIG. 4, adapted for transporting the floatable fish box 20 on land and for launching and beaching the floatable fish box 20. The floatable fish box 20 also provides a line securing element, such as a curved bracket 22 attached to the front of the floatable fish box 20, shown in FIGS. 1 and 3, which is adapted to receive a tow line (not shown) for towing the floatable fish box 20 behind a boat.

In use the hollow interior 14 of the floatable fish box 20 may be filled with ice, water, beverages and spear fishing equipment. To launch the device 20, the front handle 24A may be lifted, thereby allowing the floatable fish box 20 to rest on a pair of rear wheels 29, and be pulled into the water.

After fish have been speared the user may grasp a handle 24A, 24B, 24C, or 2D on a side of the floatable fish box 20, for stability while loading speared fish into the top opening 10 in the hatchway 27. Once the fish are inside the hollow interior 14, the removable cover 12 is placed over the opening in the hatchway 27 and a latch 13 secured to maintain the cover 12 in place over the hatch 27 opening to prevent losing any speared fish and avoid attracting sharks.

To beach the floatable fish box 20, the front handle 24A may be lifted, thereby allowing the device 20 to rest on a pair of rear wheels 29, and be pulled to transport the floatable craft 20 on land.

It is understood that the preceding description is given merely by way of illustration and not in limitation of the invention and that various modifications may be made thereto without departing from the spirit of the invention as claimed.

1. A floatable fish box for spear fishing comprises:
a floatable craft comprising an external shell with a hollow interior adapted for floating and storing speared fish, an elevated hatchway with a top opening and a removable cover over the opening and a seal between the cover and the hatch opening and a secure latch to maintain the cover in place over the hatch opening to prevent losing any speared fish and avoid attracting sharks, the elevated hatch having an external display area on at least two sides for displaying a dive flag;
a means for storing at least one spear gun attached to an exterior of the shell;
a recessed spool within the external shell at a front end of the floatable craft, the recessed spool adapted for holding line for multiple uses including a spear line, an anchor line, and a tow line;
a front handle and a pair of rear wheels adapted for transporting the floatable craft on land and for launching and beaching the floatable craft;

2. The floatable fish box of claim 1 further comprising at least one handle on each side of the craft for grasping while loading in speared fish into the opening in the hatchway.

3. The floatable fish box of claim 1 wherein the external shell is sufficiently insulated so that the hollow interior is adapted to hold ice and water for preserving any speared fish and food and beverages stored therein.

4. The floatable fish box of claim 1 wherein the hollow interior is sufficiently large to store spear fishing equipment in addition to any speared fish.

5. The floatable fish box of claim 1 wherein the external shell is formed of blow molded plastic.

6. The floatable fish box of claim 1 further comprising a line securing element attached to the front of the floatable fish box adapted to receive a tow line for towing the floatable fish box behind a boat.
